(19) United States
(12) Patent Application Publication
(10) Pub. No.: US 2005/0139450 A1
(43) Pub. Date: Jun. 30, 2005

(54) Electrical part processing unit

(75) Inventors: Merlin E. Behnke, Grafton, WI (US); Michael J. Reilly, Mukwonago, WI (US); Kenneth J. Pikus, Franklin, WI (US)

Correspondence Address: MICHAEL BEST & FRIEDRICH, LLP, 100 E WISCONSIN AVENUE, MILWAUKEE, WI, 53202, US

(73) Assignee: International Product Technology, Inc., New Berlin, WI (US)

(21) Appl. No.: 11/021,388

(22) Filed: Dec. 23, 2004

Related U.S. Application Data
(60) Provisional application No. 60/533,463, filed on Dec. 30, 2003.

(51) Int. Cl. B65G 47/26

(52) U.S. Cl. 198/459.1

(57) ABSTRACT

A part singulator mechanism for spacing parts along a path includes a path defined by a track, a drive mechanism, at least one first stopping member, and at least one second stopping member. Both the first and second stopping members are interconnected with the drive mechanism, positioned adjacent the path, and movable between a first position extended into the path and a second position retracted from the path. The first stopping members and the second stopping members are arranged in an alternating sequence along the path. When the first stopping members are in the first position, the second stopping members are in the second position, and when the first stopping members are in the second position, the second stopping members are in the first position.

### CROSS-REFERENCE TO RELATED APPLICATION

This application claims priority from Provisional Application No. 60/533,463 filed Dec. 30, 2003 for “Electrical Part Processing Unit” by Merlin E. Behnke.

### BACKGROUND OF THE INVENTION

The present invention relates to apparatuses for packaging electrical parts and, more particularly, to apparatuses for singulating electrical parts and methods of operating the apparatuses.

A variety of packaging apparatus are used to package electrical parts such as electronic computer chips, microprocessors, and the like. A group of electrical parts are fed to a part tray or tooling track of the packaging apparatus. Such packaging apparatuses include infeed part heads for vertically picking up the electrical parts from the horizontal electrical part tray, or tooling track, and placing the electrical parts vertically downward into a horizontal carrier tape or some other horizontal packaging device. The packaging apparatuses also include a linear actuator for linearly moving the part head between the tray or track and the carrier tape. Typically, the part head is vacuum operated and includes a vacuum nozzle for picking up the electrical part.

### SUMMARY OF THE INVENTION

In one embodiment, the invention provides a part singulator mechanism for spacing parts along a path. The part singulator mechanism includes a path defined by a track and a drive mechanism. The part singulator mechanism also includes at least one first stopping member interconnected with the drive mechanism and positioned adjacent the path, the first stopping members are movable between a first position extended into the path and a second position retracted from the path. In addition, the part singulator mechanism includes at least one second stopping member interconnected with the drive mechanism and positioned adjacent the path, the second stopping members are movable between a first position extended into the path and a second position retracted from the path. The first stopping members and the second stopping members are arranged in an alternating sequence along the path. When the first stopping members are in the first position, the second stopping members are in the second position, and when the first stopping members are in the second position, the second stopping members are in the first position.

In another embodiment, the invention provides a part singulator mechanism for spacing parts along a path. The part singulator mechanism includes a path defined by a track; a drive mechanism including a first cam member and a second cam member; a plurality of first stopping members interconnected with the first cam member and positioned adjacent the path, the first stopping members being movable between a first position extended into the path and a second position retracted from the path; and a plurality of second stopping members interconnected with the second cam member and positioned adjacent the path, the second stopping members being movable between a first position extended into the path and a second position retracted from the path. The first stopping members and the second stopping members are arranged in an alternating sequence along the path. The first and second cam members are about 180° out of phase with each other such that when the first stopping members are in the first position, the second stopping members are in the second position, and when the first stopping members are in the second position, the second stopping members are in the first position.

In yet another embodiment, the invention provides a method of singluating a plurality of parts and spacing the parts a selected distance along a path. The method includes feeding a line of parts along a track to a singulating station wherein the track defines a path, stopping a first part in the line of parts at a first stopping member positioned in the path, and stopping a second part adjacent and upstream of the first part in the line of parts upstream from the first stopping member wherein the second part is stopped by a stopping mechanism. The first stopping member is removed from the path to permit the first part to advance along the path whereby the first part is stopped at a second stopping member positioned in the path. Substantially simultaneously with the first part stopping at the second stopping member, the second part is released from the stopping mechanism to permit the second part to advance along the path, and the first stopping member is moved into the path to stop the second part.

In a further embodiment, the invention provides a method for singluating a plurality of parts along a path. The method includes driving a plurality of first stopping members positioned adjacent the path between a first position extended into the path and a second position retracted from the path, and driving a plurality of second stopping members positioned adjacent the path between the second position and the first position. The first stopping members and the second stopping members are arranged in an alternating sequence. When the first stopping members are in the first position, the second stopping members are in the second position, and when the first stopping members are in the second position, the second stopping members are in the first position. The method further includes feeding a line of parts along the path upstream of the first and second stopping members, stopping a first part in the line of parts at a leading first stopping member in the first position, and stopping a second part that is adjacent and upstream of the first part in the line of parts upstream of the first and second stopping members to prevent further advancement of the line of parts. The leading first stopping member is moved to the second position to permit the first part to advance along the path, and the first part is stopped at a leading second stopping member in the first position. Next, the leading second stopping member is moved to the second position to permit the first part to advance along the path. Substantially simultaneously, the first part is stopped at a subsequent first stopping member in the first position and the second part is released and advanced to the leading first stopping member in the first position.

Other aspects of the invention will become apparent by consideration of the detailed description and accompanying drawings.

### BRIEF DESCRIPTION OF THE DRAWINGS

FIG. 1 is a side view of an electrical part processing unit embodying aspects of the present invention.

FIG. 2 is a cross-sectional view of an infeed track of the part processing unit taken along line 2-2 in FIG. 1.

FIG. 3 is a cross-sectional view similar to the cross-sectional view taken along line 2-2 of an alternative construction of an infeed track of the part processing unit.

FIG. 4 is a cross-sectional view similar to the cross-sectional view taken along line 2-2 of another alternative construction of an infeed track of the part processing unit.

FIG. 5 is a partial cross-sectional view of an electrical part singulator mechanism of the part processing unit shown in FIG. 1 in a first singulating position.

FIG. 6 is a partial cross-sectional view of the singulator mechanism shown in FIG. 5 in a second singulating position.

FIG. 7 is a partial cross-sectional view of the singulator mechanism shown in FIG. 5 in a third singulating position.

FIG. 8 is a partial cross-sectional view of the singulator mechanism shown in FIG. 5 in a fourth singulating position.

FIGS. 9-14 are side views of a pick-and-place (PNP) assembly of the processing unit shown in FIG. 1, shown in multiple operating positions.

FIGS. 15-18 are each side views of alternative constructions of an electrical part handling mechanism of the processing unit shown in FIG. 1, all shown without a PNP assembly.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION OF THE PREFERRED EMBODIMENT

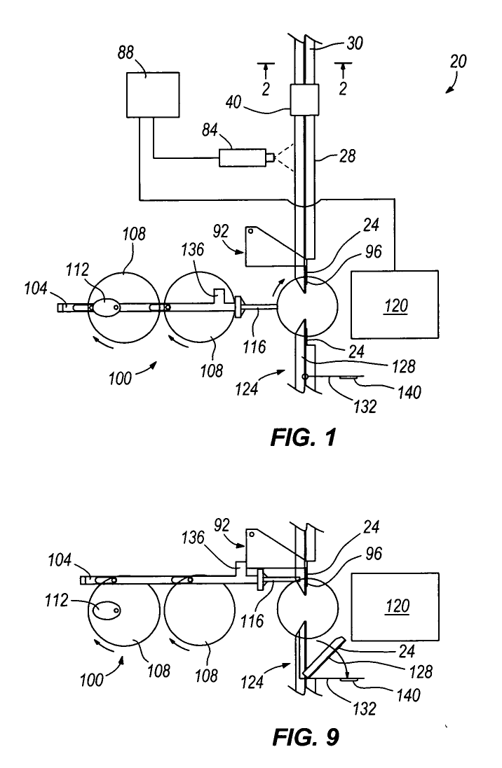

FIG. 1 illustrates an electrical part processing unit 20 for packaging and/or inspecting electrical parts 24. The processing unit 20 includes an infeed tooling track 28 on which electrical parts 24 are introduced into the processing unit 20. In the illustrated embodiment, the infeed track 28 is substantially vertically oriented and a line of electrical parts 24 are advanced downstream along the infeed track 28 under the force of gravity from a feed end 30 of the processing unit 20. In further embodiments of the invention, the infeed track 28 is oriented in a position other than vertical, such as, for example inclined with respect to horizontal, to feed the electrical parts 24 downstream under the force of gravity.

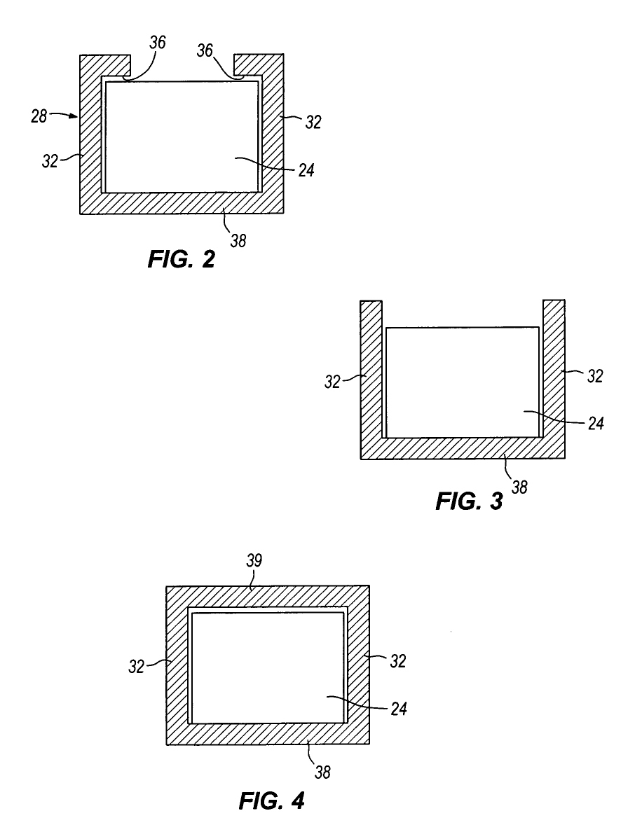

FIG. 2 illustrates a cross-sectional view of the infeed track 28. The infeed track 28 includes a pair of side walls 32, a flange 36 extending inwardly at one end of each side wall 32, and a base wall 38 connecting the opposite ends of side walls 32. The parts 24 advance along the base wall 38 of the infeed track 28. The flanges 36 capture the electrical parts 24 between the base wall 38 and the flanges 36 to prevent the electrical parts 24 from falling off the infeed track 28 or from stacking upon other electrical parts 24 within the infeed track 28.

With reference to FIG. 3, an alternative embodiment of the infeed track 28 is illustrated. The infeed track 28 includes a pair of side walls 32 and a base wall 38. In this embodiment, the infeed track 28 is inclined to support the electrical parts 24 on the track 28 from underneath, or the infeed track 28 includes a track vacuum operable to vacuumly secure the electrical parts 24 to the infeed track 28 in order to prevent the electrical parts 24 from falling off the infeed track 28. In constructions where the infeed track 28 includes a track vacuum, the track vacuum is utilized to advance the electrical parts 24 downstream along the infeed track 28 whereby the track vacuum is used in combination with gravity to assist in advancing the electrical parts 24 downstream.

With reference to FIG. 4, another alternative embodiment of the infeed track 28 is illustrated. The infeed track 28 includes side walls 32, a base wall 38 and a top wall 39 to completely surround the electrical part 24. In this embodiment, the electrical part 24 is surrounded on all sides to prevent the electrical part from falling off the infeed track 28 or from stacking upon other electrical parts 24.

With reference to FIGS. 1 and 5-8, the processing unit 20 includes an electrical part singulator mechanism 40 for singulating the electrical parts 24 and spacing the parts 24 along the infeed track 28. The singulator mechanism 40 includes a drive mechanism 44, a first support member 48, and a second support member 52. In the illustrated embodiment, the first support member 48 is positioned forward of the second support member 52 with respect to the drive mechanism 44, however, in further embodiments of the invention the first support member may be positioned rearward to or adjacent with the second support member. In the illustrated embodiment, the drive mechanism 44 is either a servo motor or a stepper motor.

The drive mechanism 44 includes a first cam member 56 and a second cam member 60, which are about 180° out of phase with each other. The first cam member 56 cams against the first support member 48 to move the first support member 48 relative to the infeed track 28 and the second cam member 60 cams against the second support member 52 to move the second support member 52 relative to the infeed track 28. Biasing members bias the first and second support members 48, 52 against the respective first and second cam members 56, 60. The first and second support members 48, 52 may therefore be considered cam followers. In further embodiments, other drive means may be used to move the first and second support members 48, 52 with respect to the infeed track 28.

The first and second support members 48, 52 each include a plurality of respective first and second stopping members 64, 68 that extend into and through the infeed track 28. The second stopping members 68 also extend through the first support member 48 in the illustrated construction. Rotational movement of the first and second cam members 56, 60 is converted into reciprocal movement of the first and second stopping members 64, 68 as the first and second support members 48, 52 follow the cam profiles of the first and second cam members 56, 60. The range of motion of the first and second support members and stopping members 48, 52, 64, 68 is between a first or extended position and a second or retracted position.

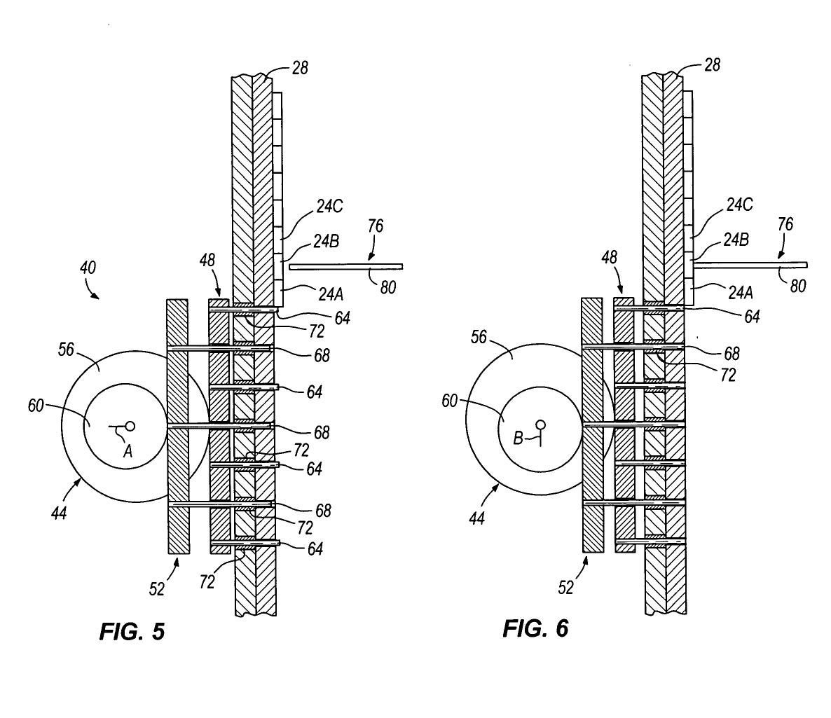

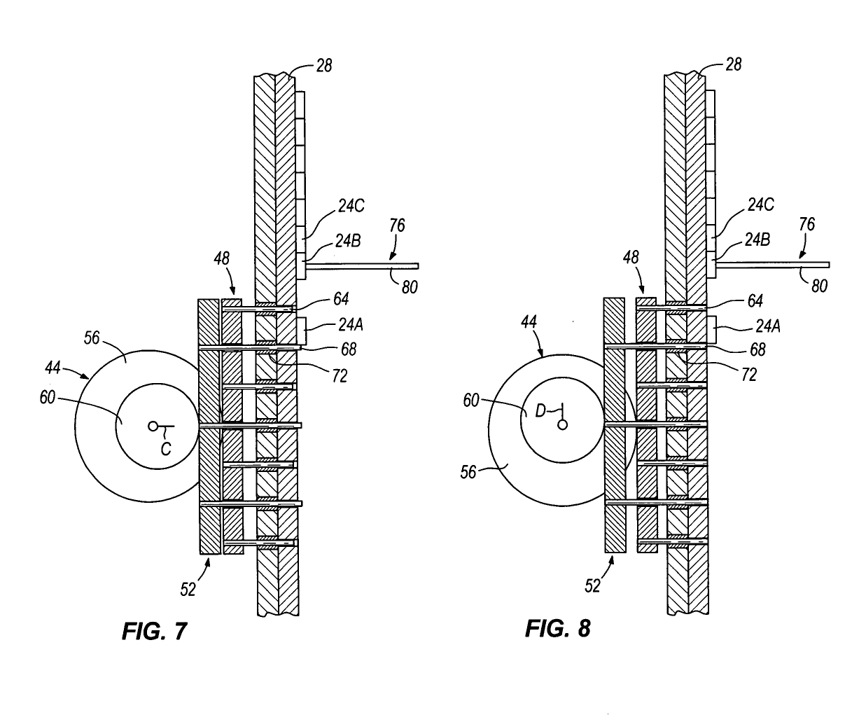

FIG. 5 illustrates the first support and stopping members 48, 64 in the extended position, and FIG. 7 illustrates the second support and stopping members 52, 68 in the extended position. The stopping members 64 or 68 in the extended position are extend into the electrical parts path defined by the infeed track 28 and obstruct the movement of parts 24 along the track 28. FIG. 5 illustrates the first support and stopping members 48, 64 in the retracted position, and FIG. 7 illustrates the second support and stopping members 52, 68 in the retracted position. The stopping members 64 or 68 in the retracted position are withdrawn from the electrical parts path defined by the infeed track 28, and parts 24 are permitted to slide along the track past the retracted stopping members 64 or 68.

Because of the first and second support members are essentially cam followers, rotation of the cam members 56, 60 cyclically (and about 180° out of phase with each other) push the respective first and second support members 48, 52 and their respective stopping members 64, 68 toward the extended position against the biasing force, and permit the respective support members 48, 52 and associated stopping members 64, 68 to move under the biasing force toward the retracted position.

The first and second stopping members 64, 68 are positioned in an alternating sequence within the singulator mechanism 40, as shown in FIG. 5. Each of the stopping members 64, 68 extend through a bearing 72 positioned in the infeed track 28. The bearings 72 ease movement of the stopping members 64, 68 relative to the infeed track 28. Although in the illustrated embodiment, the first stopping members 64 are moveable in unison with one another and the second stopping members 68 are movable in unison with one another, it is within the scope of the invention to provide independent actuating means for each stopping member 64, 68. In the illustrated embodiment, the stopping members are pins, however, those skilled in the art will recognize that other stopping means may be used to extend and retract with respect to the infeed track and stop movement of electrical parts along the track. Although multiple first and second stopping members are shown in the illustrated embodiment, a minimum of two stopping members may be used in the invention.

The singulator mechanism 40 also includes a stopping mechanism 76 for stopping the line of electrical parts 24 positioned upstream of the first and second stopping members 64, 68. In the illustrated embodiment, the stopping mechanism 76 is a stop pin 80 that may operate in response to rotation of the cam members 56, 60 or have its own cam or other actuating mechanism. The stopping mechanism 76 engages a second electrical part 24B in the line of electrical parts 24 to force the second electrical part 24B against the infeed track 28. Such engagement prevents downstream movement of the second electrical part 24B and the electrical parts 24 upstream of the second electrical part 24B. In a further embodiment of the invention, the stopping mechanism 76 may incorporate a vacuum mechanism operable to hold with vacuum pressure the second electrical part 24B against the track 28, and thereby prevent downstream movement of the second electrical part 24B and the electrical parts 24 upstream of the second electrical part 24B. In the illustrated embodiment, the stopping mechanism is a pin, however, those skilled in the art will recognize that other stopping means may be used to extend and retract with respect to the infeed track and stop movement of electrical parts along the track.

Referring back to FIG. 1, the processing unit 20 also includes a first inspection unit 84 for inspecting a top surface of the electrical parts 24. In the illustrated embodiment, the first inspection unit 84 is positioned downstream of the singulator mechanism 40. In further embodiments, the first inspection unit 84 is positioned upstream of the singulator mechanism 40 or in the same position as the singulator mechanism 40 to inspect the electrical parts 40 as they pass through the singulator mechanism 40. In operation, the first inspection unit 84 is electrically connected to a controller 88 of the processing unit 20. The controller 88 is operable to control multiple aspects of the processing unit 20. The first inspection unit 84 relays to the controller 88 whether the top surfaces of the electrical parts 24 are acceptable or unacceptable.

With reference to FIGS. 1 and 9-14, the processing unit 20 also includes a part positioning mechanism 92 positioned downstream of the singulator mechanism 40. In the illustrated embodiment, the part positioning mechanism 92 is in-line with the infeed track 28 and stops the leading electrical part 24A along the infeed track 28 adjacent a pick-and-place (PNP) assembly 100 (discussed below). The illustrated part positioning mechanism 92 includes a vacuum portion 96 that secures the leading electrical part 24A using vacuum pressure in a position to be engaged by the PNP assembly 100.

The part positioning mechanism 92 is rotateable into and out of alignment with the infeed track 28 and into and out of engagement with the leading electrical part 24A to release the leading electrical part 24A from the vacuum portion 96 of the part positioning mechanism 92. In further embodiments, the part positioning mechanism 92 is moveable in manners other than rotation, such as by linear translation. In another embodiment, the part positioning mechanism 92 includes a moveable member that engages the leading electrical part 24A to stop and position the leading electrical part 24A in position along the infeed track 28. The moveable member can be moved in a variety of manners, such as, for example pneumatically, spring biased, cammed, etc. In yet another embodiment, the part positioning mechanism 92 is positioned out-of-line with the infeed track 28 and engages the leading electrical part 24A to properly position the leading electrical part 24A for engagement by the PNP assembly 100.

With continued reference to FIGS. 1 and 9-14, the processing unit 20 further includes the PNP assembly 100, which engages and removes a leading electrical part 24A in the line of electrical parts 24 from the infeed track 28. The PNP assembly 100, has a spindle 104, a pair of large cams 108, a small cam 112, and a PNP nozzle 116 connected to the spindle 104. The large cams 108 and the small cam 112 are rotateably connected to the spindle 104 and rotate to move the spindle 104 (discussed below). The PNP nozzle 116 is connected to the end of the spindle 104 and is in fluid communication with a vacuum source (not shown). The PNP nozzle 116 is operable to engage the leading electrical part 24A and vacuumly secure the leading electrical part 24A thereto. In the illustrated embodiment, the spindle 104 is oriented substantially perpendicular to the infeed track 28 and is moveable toward and away from the infeed track 28 to engage the leading electrical part 24A retained in position by the part positioning mechanism 92. The PNP nozzle 116, operable by the spindle 104, removes the leading electrical part 24A from the part positioning mechanism 92, positions the leading electrical part 24A for inspection, and places the leading electrical part 24A in a downstream part handling mechanism 124 (discussed below).

With continued reference to FIGS. 1 and 9-14, the processing unit 20 further includes a second inspection unit 120 for inspecting sides and bottom surfaces of the electrical parts 24. The second inspection unit 120 is electrically connected to the controller 88 to relay whether the sides and/or the bottom surfaces of the electrical parts 24 are acceptable or unacceptable. The second inspection unit 120 can be any inspection mechanism operable to inspect sides and the bottom surfaces of the electrical parts 24.

The processing unit 20 further includes an electrical part handling mechanism 124 for receiving the electrical parts 24 from the PNP assembly 100 and advancing the electrical parts 24 downstream along the processing unit 20. In the illustrated embodiment, the handling mechanism 124 is positioned downstream of the second inspection unit 120. The handling mechanism 124 includes a rotateable arm 128 for receiving the electrical parts 24 from the PNP assembly 100 (discussed below) and rotating to deposit the electrical parts 24 into an empty compartment 140 of a carrier tape 132 or other packaging device.

Now that the components of the part processing unit 20 have been described, operation of the processing unit 20 will be described hereafter with respect to the processing of electrical parts 24. In the processing unit 20 shown in FIG. 1, the electrical parts 24 are initially fed to the singulator mechanism 40, shown in FIGS. 5-8, for singulating and spacing parts 24 along the infeed track 28. The singulation process begins in FIG. 5 with a line of electrical parts 24 being fed into the processing unit 20 along the infeed track 28. In FIG. 5, the cams 56, 60 are in a first position designated by the reference letter A. The first cam 56 pushes the first support and stopping members 48, 64 into the extended position. The leading electrical part 24A abuts the leading first stopping member 64 of the first support member 48, which prevents downstream movement of the leading electrical part 24A along the path. The second cam 60 permits the second support and stopping members 52, 68 to move into the retracted position. At this point, the stopping mechanism 76 is moved away from the infeed track 28 and does not abut against any electrical part 24 in the line of parts.

The drive mechanism 44 continues to rotate the cams 56, 60 to a second position, designated by reference letter B in FIG. 6. At this point during the singulation process, the stopping mechanism 76 abuts against the second electrical part 24B in the line of electrical parts 24. The stopping mechanism 76 holds the second electrical part 24B against the infeed track 28 to prevent downstream movement of the electrical parts 24 upstream from the leading electrical part 24A along the infeed track 28. The first cam 56 now permits the first support member and stopping members 48, 64 to move toward the retracted position, and the second cam 60 moves the second support and stopping members 52, 68 towards the extended position.

In FIG. 7, the drive mechanism 44 rotates the first and second cam members 56, 60 to a third position, designated by reference letter C. The first cam member 56 now permits the first support and stopping members 48, 64 to move into the retracted position, and the second cam member 60 moves the second support and stopping members 52, 68 into the extended position. The leading electrical part 24A advances downstream under the influence of gravity until it abuts the leading second stopping member 68. The electrical parts 24 upstream of the leading electrical part 24A are maintained in position by the stopping mechanism 76 that abuts against the second electrical part 24B.

FIG. 8, the drive mechanism 44 rotates the first and second cam members 56, 60 to a fourth position, designated by reference letter D. The first cam member 56 now moves the first support and stopping members 48, 64 toward the extended position, and the second cam member 60 permits the second support and stopping members 52, 68 to move toward the retracted position.

The drive mechanism 44 continues to rotate the first and second cam members 56, 60 to the first position shown in FIG. 5, which completes a cycle by positioning the first support and stopping members 48, 64 in the extended position and the second support and stopping members 52, 68 in the retracted position.

As the second stopping members 68 move toward the retracted position, the leading electrical part 24A advances downstream under the force of gravity until it abuts against the subsequent first stopping member 64 in the extended position. Substantially simultaneously, the stopping mechanism 76 disengages the second electrical part 24B, which moves downstream along the infeed track 28 under the influence of gravity until is abuts against the leading first stopping member 64 in the extended position. The distance between the first stopping members 64 therefore defines the spacing between the electrical parts 24 as the parts 24 advance along the infeed track 28.

With reference to FIGS. 5-8, the drive mechanism 44 continuously rotates to move the first and second stopping members 64, 68 between the extended and retracted positions. The first and second support members 48, 52 and the stopping mechanism 76 continue to operate in the manner discussed above to advance electrical parts 24 along the infeed path 28 and simultaneously space the electrical parts 24 from one another. In the illustrated embodiment, and as a result of the 180° offset of the cam members 56, 60, when the first stopping members 64 are extended into the infeed track 28 and into the path of the electrical parts 24, i.e., the first position, the second stopping members 68 are retracted from the infeed path and out of the path of the electrical parts 24, i.e., the second position. Further, when the second stopping members 68 are extended into the infeed track 28 and into the path of the electrical parts 24, i.e., the first position, the first stopping members 64 are retracted from the infeed path and out of the path of the electrical parts 24, i.e., the second position. Thus, the first and second stopping members 64, 68 alternately move between the first position and the second position. All electrical parts 24 within the singulator 40 are supported by only the first stopping members 64 (when they are in the extended position) or only by the second stopping members (when they are in the extened position), and alternate between the two as the parts are cycled through the singulator 40.

It should be recognized by one of ordinary skill in the art that discussion of the rotation of the cam members is discussed in 90° increments for ease of description. It should also be recognized that fewer or more stopping members, or at least two first stopping members could be used to achieve the present invention.

Referring to FIG. 1, after the electrical parts 24 are singulated at the singulation mechanism 40, the electrical parts 24 advance past the first inspection unit 84. The first inspection unit 84 inspects the top surfaces of the electrical parts 24 and relays signals to the controller 88 relating to the acceptability or unacceptability of the electrical parts 24.

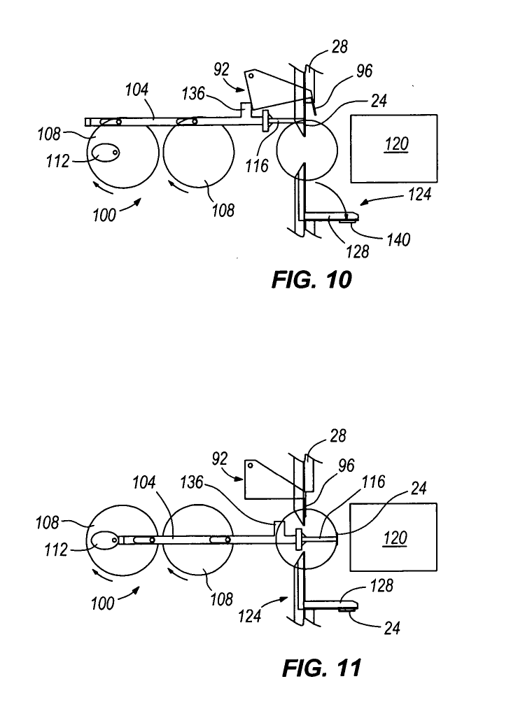

After advancing past the inspection unit 84, the electrical parts 24 advance downstream along the track 28 to the part positioning mechanism 92, which individually engages the electrical parts. The electrical parts 24 are stopped along the track 28 by vacuum pressure from the vacuum portion 96 (shown in FIG. 10) of the part positioning mechanism 92. The part positioning mechanism 92 stops the electrical parts 24 in a position that allows the PNP assembly 100 to engage the electrical parts 24 and remove the electrical parts 24 from the track 28.

In the embodiment shown in FIG. 1, the PNP assembly 100 is recessed from the inspection unit 120 and positioned between the part positioning mechanism 92 and the part handling mechanism 124. The rotateable arm 128 of the part handling mechanism 124 is positioned adjacent the PNP assembly 100. The two large cams 108 rotate to move the PNP nozzle 116 at the end of spindle 104 toward the electrical part 24 stopped along the track 28 by the part positioning mechanism 92, as shown in FIG. 9. In the illustrated embodiment, the rotateable arm 128 of the part handling mechanism rotates substantially simultaneously towards the carrier tape 132, often with an electrical part attached thereto.

As shown in FIG. 10, the two large cams 108 continue to rotate to move the spindle 104 and the PNP nozzle 116 toward the electrical part 24. The spindle 104 includes a cam surface 136 that abuts the part positioning mechanism 92 to thereby rotate the part positioning mechanism 92 to an open position. Substantially simultaneously, the vacuum of the part positioning mechanism 92 turns off to release the electrical part 24 and the PNP nozzle 116 vacuumly secures the electrical part 24 thereto. In the illustrated embodiment, the rotateable arm 128 of the part handling mechanism rotates substantially simultaneously to the carrier tape 132 for depositing an electrical part in the empty compartment 140.

In FIG. 11, the large cams 108 continue to rotate to move the spindle 104, the PNP nozzle 116, and the electrical part 24 vacuumly secured to the PNP nozzle 116 to a position adjacent the second inspection unit 120. The PNP nozzle 116 is positioned between the part positioning mechanism 92 and the part handling mechanism 124 adjacent the inspection unit 120. The cam surface 136 releases the part positioning mechanism 92 and the part positioning mechanism 92 rotates back to the original position.

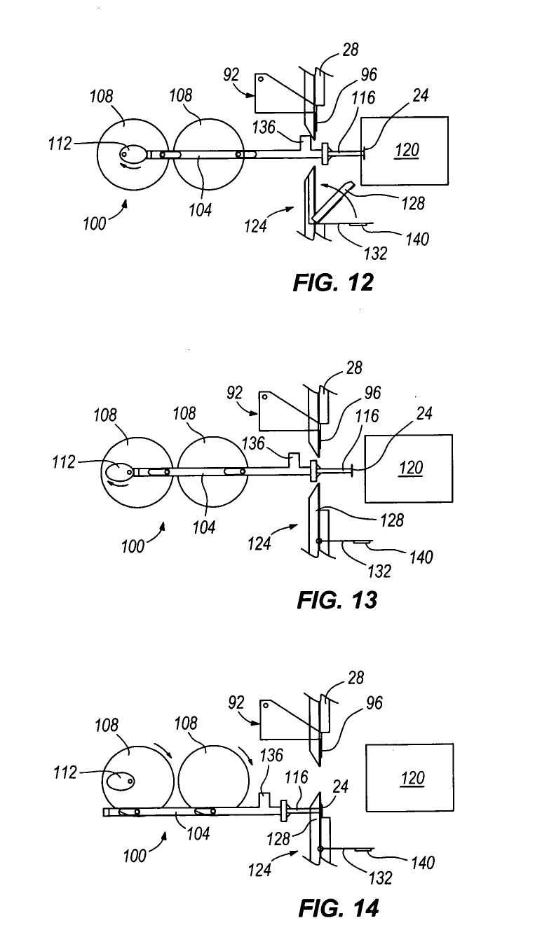

In FIG. 12, the large cams 108 cease rotating and the small cam 112 rotates to move the spindle 104 toward the inspection unit 120. Resultantly, the electrical part 24 and a portion of the PNP nozzle 116 enter the inspection unit 120. Inspection of the side walls and the bottom surface of the electrical part 24 occurs within the inspection unit 120, which relays signals to the controller 88 relating to the acceptability or unacceptability of the electrical part 24. In the illustrated embodiment, the rotateable arm 128 of the part handling mechanism rotates substantially simultaneously away from the carrier tape 132. In FIG. 13, the small cam 112 continues to rotate and moves the spindle 104 away from the inspection unit 120, which resultantly removes the electrical part 24A and the PNP nozzle 116 out of the inspection unit 120. In the illustrated embodiment, the rotateable arm 128 of the part handling mechanism 124 rotates substantially simultaneously back to its original position for receiving an electrical part 24.

In FIG. 14, the small cam 112 ceases rotating and the large cams 108 resume rotating to move the electrical part 24 vacuumly secured to the PNP nozzle 116 toward the part handling mechanism 124. Once the electrical part 24 is engaged with the part handling mechanism 124, the PNP nozzle 116 vacuum is turned off. Substantially simultaneously, the vacuum of the part handling mechanism 124 is turned on in order to remove the electrical part 24 from the PNP nozzle 116 and vacuumly secure the electrical part 24 to the part handling mechanism 124. The large cams 108 continue to rotate and move the spindle 104 shown in FIG. 1 to complete one cycle of the PNP process. The PNP process then resumes to pick another electrical part 24 from the track 28 for inspection by inspection unit 120.

During the PNP process described above and shown in FIGS. 1 and 9-14, the rotateable arm 128 of the part handling mechanism 124 picks an electrical part 24 from the PNP nozzle 116 and rotates toward the carrier tape 132 to position the electrical part 24 into a compartment 140. Once the electrical part 24 is positioned in the compartment 140 of the carrier tape 132, the vacuum of the part handling mechanism 124 is turned off and the electrical part 24 is released into the compartment 140. The rotateable arm 128 then rotates upward to receive the next electrical part 24 and the carrier tape 132 advances to align an empty compartment 140 with the rotateable arm 128 for receiving the next electrical part 24. This operation is repeated for each electrical part 24 advancing through the processing unit 20.

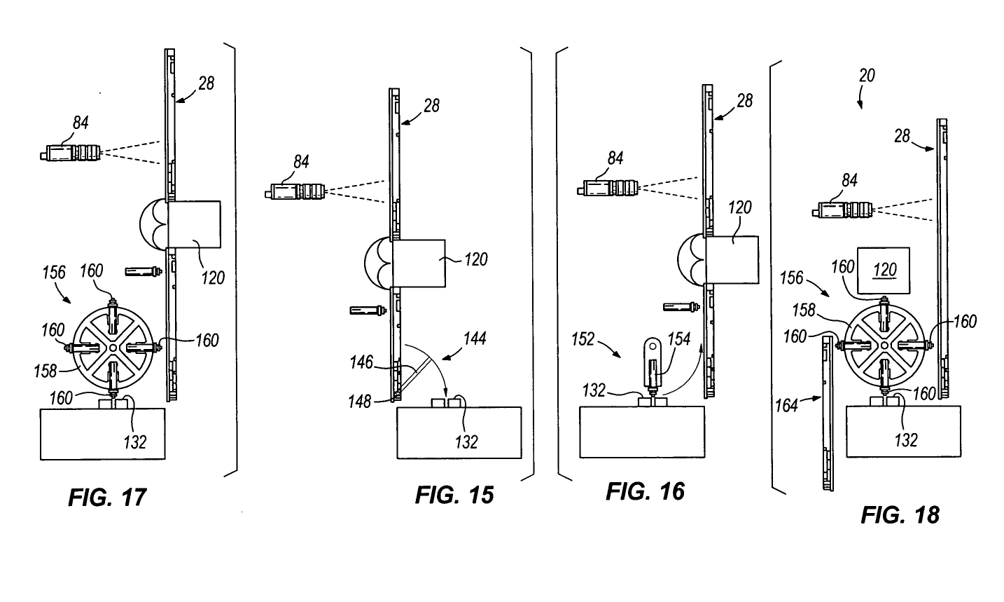

FIG. 15 illustrates an alternative construction of a part handling mechanism 144. The part handling mechanism 144 includes a dropping mechanism 146 which rotates about a pivot point 148 to position the electrical part 24 over the carrier tape 132 and drop the electrical part 24 into the carrier tape 132. Such a part handling mechanism with a dropping mechanism is disclosed in co-pending U.S. patent application Ser. No. 10/239,344, filed on Sep. 21, 2002.

FIG. 16 illustrates another alternative construction of a part handling mechanism 152. The part handling mechanism 152 includes a rotateable PNP vacuum nozzle 154 (similar to the PNP nozzle 116 of the PNP assembly 100). The part handling mechanism 152 removes the electrical parts 24 from the track 28 by vacuumly securing the electrical parts 24 to the PNP vacuum nozzle 154. After the electrical part 24 is secured to the PNP vacuum nozzle 154, the PNP vacuum nozzle 154 rotates to position the electrical part 24 over carrier tape 132. The PNP vacuum nozzle 154 then turns off the vacuum supplied to the PNP vacuum nozzle 154 to place the electrical part 24 in the carrier tape 132.

FIG. 17 illustrates yet another alternative construction of a part handling mechanism 156. The part handling mechanism 156 includes a rotateable multi-vacuum nozzle assembly 158. In the illustrated embodiment, the assembly 158 includes four vacuum nozzles 160, however in further embodiments of the assembly 158 any number of vacuum nozzles 160 can be included. Multiple vacuum nozzles 160 allow the assembly 158 to place electrical parts 24 into the carrier tape 132 much quicker than if the assembly 158 included only one vacuum nozzle.

The multi-vacuum nozzle assembly 158 is operable to subject the electrical parts 24 to additional processing steps prior to being placed into the carrier tape 132, such as other inspection operations, rejection of electrical parts, etc. In such constructions, each vacuum nozzle 160 vacuumly secures an electrical part 24 thereto and rotates counter-clockwise (as viewed in FIG. 17). The electrical parts 24 are subjected to further processing steps anywhere between being initially secured to the vacuum nozzles 160 and placing the electrical parts 24 in the carrier tape 132. Preferably, further processing steps occur at the top dead center location of the assembly 158 (above the upper vacuum nozzle 160 in FIG. 17) and at the far left location of the assembly 158 (to the left of the left most vacuum nozzle 160 in FIG. 17).

FIG. 18 illustrates an alternative construction of the part positioning mechanism and the part handling mechanism 156 shown in FIG. 17. The part handling mechanism includes the rotateable multi-vacuum nozzle assembly 158 similar to the rotateable multi-vacuum nozzle assembly described above with respect to FIG. 17. In this embodiment, the second inspection unit 120 is positioned at the top dead center location of the assembly 158, an output track 164 is positioned at the left most location of the assembly 158, and the carrier tape 132 is positioned at the bottom dead center location of the assembly 158.

Operation of the assembly 156 illustrated in FIG. 18 will be described with respect to one electrical part 24 as it advances through the processing unit 20. A vacuum nozzle 160 positioned near the infeed track 28 vacuumly secures an electrical part 24 thereto. The assembly 158 then rotates counter-clockwise to position the electrical part 24 adjacent the second inspection unit 120. The vacuum nozzle 160, with the electrical part 24 attached thereto, extends to plunge the electrical part 24 into the second inspection unit 120. After the electrical part 24 is properly inspected, the vacuum nozzle 160 retracts to remove the electrical part 24 from the second inspection unit 120.

The assembly 158 then rotates to position the electrical part 24 near the output track 164. In one embodiment, the output track 164 feeds the electrical part 24 to supporting devices (not shown) other than the carrier tape 132 in order to package the electrical parts 24 in the supporting devices, such as tubes, trays, etc. If the electrical part 24 is identified for being packaged in such supporting devices, the vacuum nozzle 160 extends to the output track 164 and releases the electrical part 24 to the output track 164. The output track 164 includes a vacuum and vacuumly secures the electrical part 24 thereto. Preferably, the vacuum nozzle 160 turns off the vacuum supply thereto substantially simultaneously with the vacuum of the output track 164 turning on.

In another embodiment, the output track 164 is a reject track and feeds electrical parts 24 that are identified as unacceptable by the inspection units 84, 120 to a rejection mechanism (not shown). If the electrical part 24 is identified as unacceptable, the vacuum nozzle 160 extends to the output track 164 and releases the electrical part 24 to the output track 164. The output track 164 includes a vacuum and vacuumly secures the electrical part 24 thereto. Preferably, the vacuum nozzle 160 turns off the vacuum supply thereto substantially simultaneously with the vacuum of the output track 164 turning on.

Whether or not the electrical part 24 is placed on the output track 164, the assembly 158 rotates to position the vacuum nozzle 160 near the carrier tape 132. If the electrical part 24 was placed on the output track 164, nothing happens at this location. However, if the electrical part 24 was not placed on the output track 164, the vacuum nozzle 160 extends to position the electrical part 24 in a compartment (not shown) of the carrier tape 132. The vacuum of the vacuum nozzle 160 is turned off to release the electrical part 24 into the carrier tape 132. This operation is repeated for each electrical part 24 advancing through the processing unit 20.

The operation of the part processing unit described above is controlled by the controller 88 to ensure a steady flow of electrical parts 24 through the part processing unit 20. In some embodiments, the drive mechanism 44, the large cams 108 and the small cam 112 of the PNP assembly 100 are mechanically connected and controlled together by the controller 88. The controller 88 properly times the drive mechanism 44 and the cams 108, 112 with respect to one another to ensure a steady flow of electrical parts 24 through the processing unit 20. In further embodiments, the drive mechanism 44 and the cams 108, 112 are not mechanically connected and may be driven independently of each other. In these embodiments, the controller 88 is connected independently to the drive mechanism 44 and the cams 108, 112 to properly time them with respect to one another and ensure a steady flow of electrical parts 24 through the processing unit 20.

It should be understood that the part processing units described above are described with respect to a single infeed track 28, a single part singulating mechanism 40, a single first inspection unit 84, a single second inspection unit 120, a single part positioning mechanism 92, a single PNP assembly 100 and a single part handling mechanism 124. However, it should be understood that the PNP assembly 100 can include multiple spindles 104, multiple sets of large and small cams 108, 112, and multiple PNP nozzles 116 in order to vacuumly secure a plurality of electrical parts 24 thereto rather than a single electrical part 24. Accordingly, the part processing unit 20 can also include multiple infeed tracks 28, multiple part singulating mechanisms 40, multiple inspections units 84, 120, multiple handling mechanisms 124, and/or multiple electrical part supporting devices such as carrier tape, tubes, etc. to accommodate such a PNP assembly 100. It should also be understood that the multiple spindles 104 of such a PNP assembly 100 are operable in unison to pick up electrical parts 24 simultaneously or operable independently of one another.

It should be further understood that the PNP assembly 100 can include any number of vacuum nozzles 116. In such embodiments, the vacuum nozzles 116 are connected to a single spindle 104 and moved in unison with each other or are connected to separate spindles 104, and either be moved in unison with each other or moved independently from each other.

It should be further understood that the PNP nozzles 116, 160 can be any shape and size to pick-up any shape and size of electrical part 24. In addition, the PNP nozzles 116, 160 can be made of a variety of appropriate materials for picking up electrical parts 24.

Although particular constructions of the present invention have been shown and described, other alternative constructions will be apparent to those skilled in the art and are within the intended scope of the present invention.

1. A part singulator mechanism for spacing parts along a path, the part singulator mechanism comprising:
a path defined by a track;
a drive mechanism;
at least one first stopping member interconnected with the drive mechanism and positioned adjacent the path, the first stopping members movable between a first position extended into the path and a second position retracted from the path; and
at least one second stopping member interconnected with the drive mechanism and positioned adjacent the path, the second stopping members movable between a first position extended into the path and a second position retracted from the path,
wherein the first stopping members and the second stopping members are arranged in an alternating sequence along the path and further wherein when the first stopping members are in the first position, the second stopping members are in the second position, and when the first stopping members are in the second position, the second stopping members are in the first position.

2. The part singulator mechanism of claim 1 wherein at least one of the first and second stopping members extends through the track to extend into the path.

3. The part singulator mechanism of claim 1, and further comprising:
a first support member for supporting the at least one first stopping member; and
a second support member for supporting the at least one second stopping member.

4. The part singulator mechanism of claim 1 wherein the drive mechanism includes a first cam interconnected with the at least one first stopping member and a second cam member interconnected with the at least one second stopping member.

5. The part singulator mechanism of claim 4 wherein the first cam member and the second cam member are about 180° out of phase with each other.

6. The part singulator mechanism of claim 4, and further comprising:
a first support member supporting the at least one first stopping member wherein the first cam member cams against the first support member; and
a second support member supporting the at least one second stopping member wherein the second cam member cams against the second support member.

7. The part singulator mechanism of claim 1, and further comprising a stopping mechanism positioned along the path upstream of the first and second stopping members, the stopping mechanism movable to selectively prevent advancement of the parts along the path.

8. The part singulator mechanism of claim 1 wherein retraction of the first and second stopping members from the path permits the parts to advance along the path under the influence of gravity.

9. The part singulator mechanism of claim 1 wherein at least one of the first and second stopping members includes a pin.

10. A part singulator mechanism for spacing parts along a path, the part singulator mechanism comprising:
a path defined by a track;
a drive mechanism including a first cam member and a second cam member;
a plurality of first stopping members interconnected with the first cam member and positioned adjacent the path, the first stopping members movable between a first position extended into the path and a second position retracted from the path; and
a plurality of second stopping members interconnected with the second cam member and positioned adjacent the path, the second stopping members movable between a first position extended into the path and a second position retracted from the path,
wherein the first stopping members and the second stopping members are arranged in an alternating sequence along the path, and
wherein the first and second cam members are about 180° out of phase with each other such that when the first stopping members are in the first position, the second stopping members are in the second position, and when the first stopping members are in the second position, the second stopping members are in the first position.

11. The part singulator mechanism of claim 10, and further comprising:
a first support member supporting the plurality of first stopping members wherein the first cam member cams against the first support member; and
a second support member supporting the plurality of second stopping members wherein the second cam member cams against the second support member.

12. The part singulator mechanism of claim 10, and further comprising a stopping mechanism positioned along the path upstream of the first and second stopping members, the stopping mechanism movable to selectively prevent advancement of the parts along the path.

13. The part singulator mechanism of claim 10 wherein at least one of the first and second stopping members extends through the track to extend into the path.

14. The part singulator mechanism of claim 10 wherein retraction of the first and second stopping members from the path permits the parts to advance along the path under the influence of gravity.

15. A method for singluating a plurality of parts and spacing the parts a selected distance along a path, the method comprising:
(a) feeding a line of parts along a track to a singulating station wherein the track defines the path;
(b) stopping a first part in the line of parts at a first stopping member positioned in the path;
(c) stopping with a stopping mechanism a second part in the line of parts, the second part being adjacent and upstream of the first part;
(d) removing the first stopping member from the path to permit the first part to advance along the path;
(e) stopping the first part at a second stopping member positioned in the path;
(f) releasing the second part from the stopping mechanism to permit the second part to advance along the path; and
(g) moving the first stopping member into the path to stop the second part, wherein steps (e) through (g) occur substantially simultaneously.

16. The method of claim 15 wherein the parts advance along the path under the influence of gravity.

17. The method of claim 15, and further comprising repeating steps (b) through (g) to advance each part in the line of parts along the path.

18. The method of claim 15, and further comprising:
(h) stopping a third part adjacent and upstream of the second part in the line of parts upstream from the first stopping member with the stopping mechanism.

19. The method of claim 15 wherein the second stopping member is spaced from the first stopping member a distance equal to the preselected distance.

20. The method of claim 15 wherein step (d) further comprises moving the second stopping member into the path.

21. The method of claim 15 wherein prior to step (e) the method further comprises:
stopping the first part at an intermediate stopping member positioned between the first and second stopping members wherein the intermediate stopping member is positioned in the path; and
removing the intermediate stopping member from the path to permit the first part to advance along the path.

22. The method of claim 21, and further comprising moving the second stopping member into the path.

23. A method for singluating a plurality of parts along a path, the method comprising:
driving a plurality of first stopping members positioned adjacent the path between a first position extended into the path and a second position retracted from the path;
driving a plurality of second stopping members positioned adjacent the path between the second position and the first position wherein the first stopping members and the second stopping members are arranged in an alternating sequence and further wherein when the first stopping members are in the first position, the second stopping members are in the second position, and when the first stopping members are in the second position, the second stopping members are in the first position;
feeding a line of parts along the path upstream of the first and second stopping members;
stopping a first part in the line of parts at a leading first stopping member in the first position;
stopping a second part that is adjacent and upstream of the first part in the line of parts upstream of the first and second stopping members to prevent further advancement of the line of parts;
moving the leading first stopping member to the second position to permit the first part to advance along the path;
stopping the first part at a leading second stopping member in the first position;
moving the leading second stopping member to the second position to permit the first part to advance along the path;
stopping the first part at a subsequent first stopping member in the first position;
releasing the second part and advancing the second part to the leading first stopping member in the first position substantially simultaneously with advancing the first part to the subsequent first stopping member; and
continuously advancing each part in the line of parts between first stopping members in the first position and second stopping members in the first position along the path until each part is downstream of the first and second stopping members.

24. The method of claim 23 wherein the parts advance along the path under the influence of gravity.

25. The method of claim 23 wherein each first stopping member is spaced from the subsequent first stopping member a selected distance to space the parts along the path.
